(19) United States
(12) Patent Application Publication
(10) Pub. No.: US 2015/0193942 A1
(43) Pub. Date: Jul. 9, 2015

(54) AUTOMATIC ALIGNMENT SYSTEM AND METHOD

(71) Applicant: Wistron Corp, New Taipei City (TW)

(72) Inventors: Yu Ting LI, New Taipei City (TW); Chen Chang HUANG, New Taipei City (TW); Shih-chung CHEN, New Taipei City (TW)

(21) Appl. No.: 14/296,406

(22) Filed: Jun. 4, 2014

(30) Foreign Application Priority Data
Jan. 6, 2014 (TW) 103100331

(51) Int. Cl. G06T 7/00; G06T 7/40; H04N 5/335

(52) U.S. Cl. CPC G06T 7/0085; H04N 5/335; G06T 7/408; G06T 2207/10004

(57) ABSTRACT

The present invention discloses an automatic alignment system. The automatic alignment system includes a stage, a movable platform, an image recognition unit and a processing unit. The stage is used to be placed on an object under test. The movable platform is disposed above the stage. The image recognition unit disposed on the movable platform captures a plurality of edge images of the object under test by way of the movable platform moving along the edge of the object under test. The processing unit receives and analyzes each of the edge images from the image recognition unit. The processing unit determines whether each of the edge images is a corner image of the object under test or not and estimates the position of the corner of the object under test corresponding to the stage when the edge image is determined to be the corner image.

### BACKGROUND OF THE INVENTION

1. Field of the Invention

The present invention relates to an automatic alignment system, and more particularly, to an automatic alignment system using an image recognition unit to assist an alignment device.

2. Description of the Related Art

Due to the ever-changing nature of touch products, testing requirements are different. With operating system Win8 appearing on the market, testing requirements have changed. The alignment device such as a scribing device that is currently the most widely used in the industry is mainly manipulated by manual alignment, in which alignment device only has positioning and movement functions. It consumes a lot of manpower and material resources when conducting a scribe test. It also causes inaccurate alignment and the scribe test is not easy to perform. Sometimes the deviation caused by an inaccuracy in manual alignment results in the need to reverify the testing process.

FIG. 1 is a schematic diagram showing an alignment device 10 for testing an object under test 103 on a stage 104, wherein the alignment device 10 includes a movable platform 101, a scribing device 102 and the stage 104. The currently available technology performs the scribe test through assistance of the human eye and the human hand to ensure that the scribing device 102 is aligned with the specific position of the object under test 103. Human errors can often necessitate re-authentication of the testing process described above.

### BRIEF SUMMARY OF THE INVENTION

An embodiment of the present invention provides an automatic alignment system. The automatic alignment system comprises a stage, a movable platform, an image recognition unit and a processing unit. The stage is placed on an object under test. The movable platform is disposed above the stage. The image recognition unit disposed on the movable platform captures a plurality of edge images of the object under test by way of the movable platform moving along the edge of the object under test. The processing unit coupled to the image recognition unit receives and analyzes each of the edge images from the image recognition unit. The processing unit determines whether each of the edge images is a corner image of the object under test or not. The processing unit estimates the position of the corner of the object under test corresponding to the stage when the edge image is determined to be the corner image.

An embodiment of the present invention provides an automatic alignment method. The automatic alignment method includes the steps of: placing an object under test on a stage; disposing a movable platform above the stage; disposing an image recognition unit on the movable platform; capturing, by the image recognition unit, a plurality of edge images of the object under test by way of the movable platform moving along the edge of the object under test; receiving and analyzing, by a processing unit, each of the edge images from the image recognition unit; determining, by the processing unit, whether each of the edge images is a corner image of the object under test or not; and estimating, by the processing unit, the position of the corner of the object under test corresponding to the stage when the edge image is determined to be the corner image.

### BRIEF DESCRIPTION OF THE DRAWINGS

The invention can be more fully understood by reading the subsequent detailed description and examples with references made to the accompanying drawings, wherein:

FIG. 1 is a schematic diagram showing an alignment device 10 for testing an object under test 103 on a stage 104.

FIG. 2 is a schematic diagram showing an automatic alignment device 20 of the present invention for testing an object under test 203 on a stage 204.

FIG. 3 shows the edge images 301˜318 are captured of the object under test 203 on the stage 204 by the image recognition unit 205 of the FIG. 2.

FIG. 4 shows an automatic alignment system 40 provided according to an embodiment of the present invention.

FIG. 5 is a flow diagram illustrating how the processing unit 405 analyzes the edge images to obtain the position (corner) information of the object under test 410.

FIG. 6A shows the processing unit 405, through the above steps S501˜S503, analyzing the edge image 301 and obtaining an edge segment 61 of the edge image 301.

FIG. 6B shows the processing unit 405, through the above steps S501˜S503, analyzing the edge image 302 and obtaining an edge segment 62 of the edge image 302.

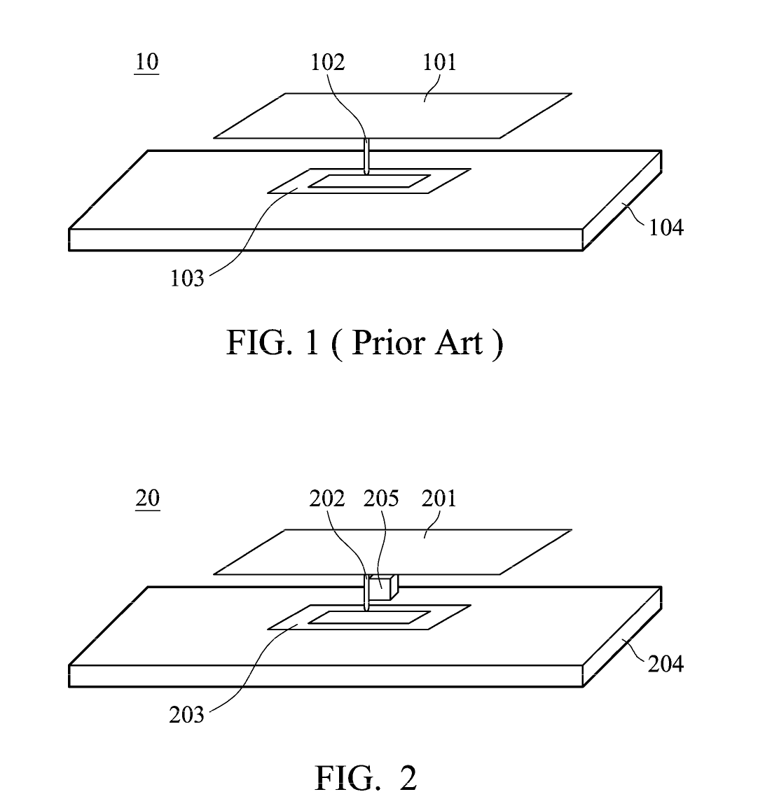

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims

FIG. 2 is a schematic diagram showing an automatic alignment device 20 of the present invention for testing an object under test 203 on a stage 204. The automatic alignment device 20 includes a movable platform 201, a scribing device 202, the stage 204 and an image recognition unit 205. In this embodiment, the movable platform 201 moves along the edge of the object under test 203 and the image recognition unit 205 captures a plurality of edge images of the object under test 203. The automatic alignment device 20 of the present invention analyzes the edge images and obtains the positions of the corners of the object under test 203 which are located on the stage 204.

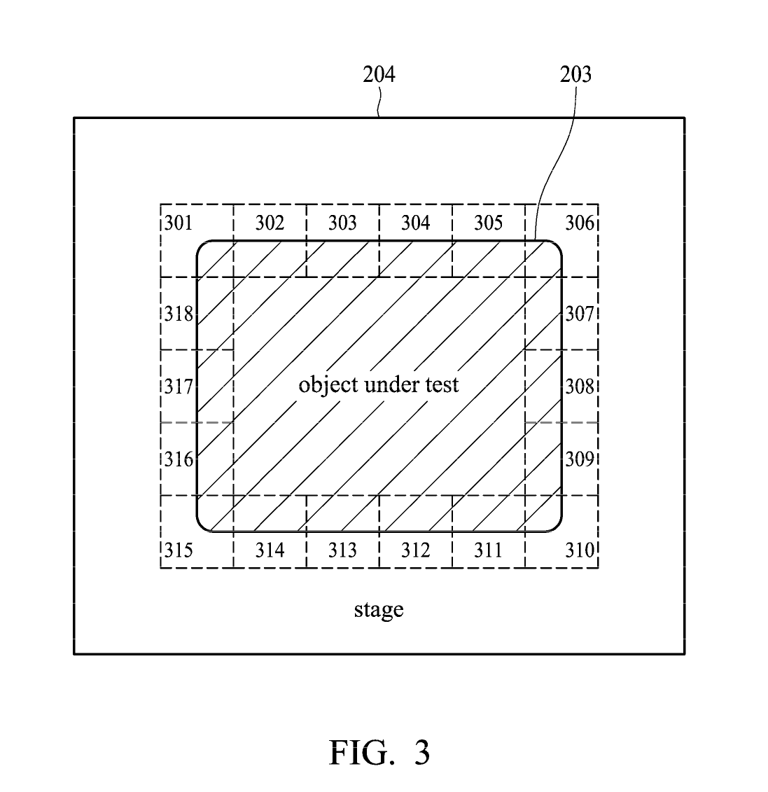

FIG. 3 shows the edge images 301˜318 of the object under test 203 on the stage 204, wherein the edge images 301˜318 are captured by the image recognition unit 205 shown in FIG. 2. In FIG. 3, the photographable range of each of the edge images 301˜318 contains part of the edge of the object under test 203, wherein the photographable ranges of the edge images 301, 306, 310 and 315 respectively contain a corner of the object under test 203 and the photographable range of the edge images 302˜305, 307˜309, 311˜314 and 317˜318 respectively contain part of the edge of the object under test 203. It is noticeable that the photographable range of the image recognition unit 205 is not limited to the photographable range of each of the edge images 301˜318.

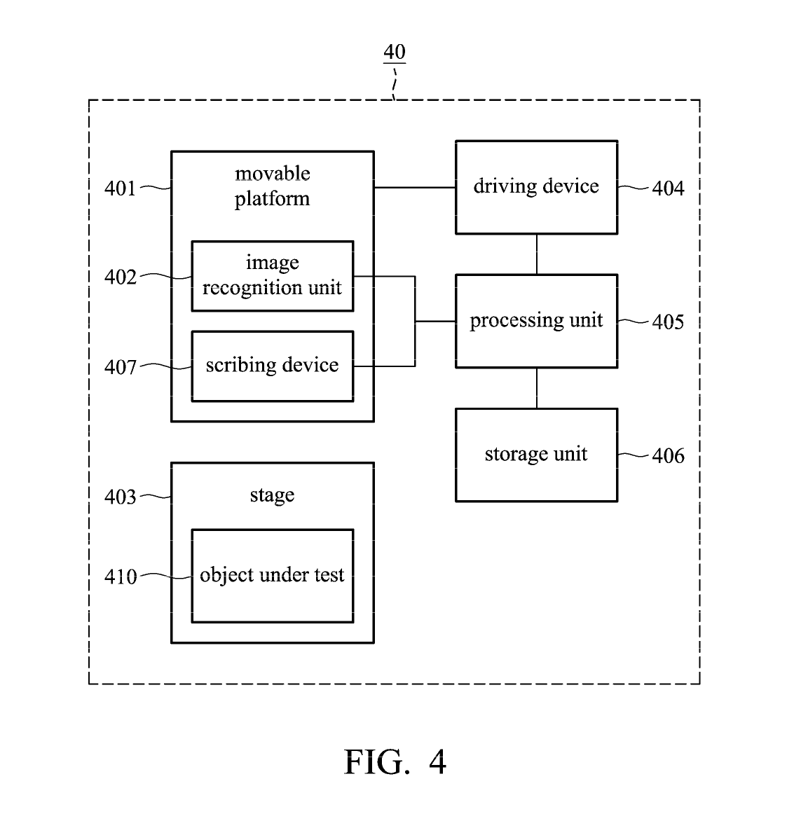

FIG. 4 shows an automatic alignment system 40 according to another embodiment of the present invention. As shown in FIG. 4, the automatic alignment system 40 includes a movable platform 401, an image recognition unit 402, a stage 403, a driving device 404, a processing unit 405, a storage unit 406 and a scribing device 407. In this embodiment of the present invention, the automatic alignment system 40 tests an object under test 410 on the stage 403. The movable platform 401 disposed above the stage 403 equips the image recognition unit 402 and the scribing device 407. The object under test 410 is placed on the stage 403. The processing unit 405 is coupled to the image recognition unit 402, the driving device 404, the storage unit 406 and the scribing device 407. The driving device 404 is coupled to the movable platform 401 and receives the instructions transmitted from the processing unit 405 to move the movable platform 401. Additionally, it is noticeable that the automatic alignment device 20 that performs a test on the object under test 203 which is on the stage 204 (as shown in FIG. 2) is a specific embodiment of the automatic alignment system 40.

Throughout the testing process, the movable platform 401 moves a circle around the edge of the object under test 410. The image recognition unit 402 which is disposed on the movable platform 401 captures a plurality of edge images of all the edges of the object under test 410 during the process of moving. For the convenience of explanation in the embodiment of FIG. 3, the image recognition unit 402 captures a plurality of edge images 301˜318 while the movable platform 401 moves in a circle around the edge of the object under test 410. Additionally, although any two adjacent edge images do not have an overlapping portion shown in FIG. 3, it is allowable for there to be existing overlapping portions between any two adjacent edge images in practical application, and it does not affect the operation of the present invention.

After the image recognition unit 402 captures the edge image 301, the image recognition unit 402 transmits the edge image 301 to the processing unit 405. Then the processing unit 405 analyzes the edge image 301 and determines that the edge image 301 is a corner image of the object under test 410. The processing unit 405 estimates the position (corner) information of the corner corresponding to the stage 403 in the edge image 301. The processing unit 405, through the position, controls the driving device 404 to move the movable platform 401 such that the movable platform 401 can change directions while passing through the top of the corner of the object under test 410. In this way, the movable platform 401 can move along the edge of the object under test 410.

After the movable platform 401 has moved once around the edge of the object under test 410, the processing unit 405 has analyzed the edge images 301˜318 and determined whether each of the edge images 301˜318 is a corner image of the object under test 410 or not. If the judgment is yes, the processing unit 405 estimates the position (corner) information of the corner corresponding to the stage 403. Therefore the processing unit 405 can obtain the position of all the corners of the object under test 410. Additionally, the processing unit 405 can obtain the moving distance of the movable platform 401 while controlling the driving device 404 moving the movable platform 401.

The processing unit 405 estimates the shape of the object under test 410 according to the moving distance and the position of all the corners of the object under test 410. Finally, the processing unit 405 stores all the position (corner) information and the shape of the object under test 410 into the storage unit 406. After the processing unit 405 obtains all the position (corner) information and the shape of the object under test 410, the processing unit 405 controls the scribing device 407 performing the scribe test functions. Or the processing unit 405 controls the scribing device 407 performing the scribe test functions while obtaining the position (corner) information of the object under test 410.

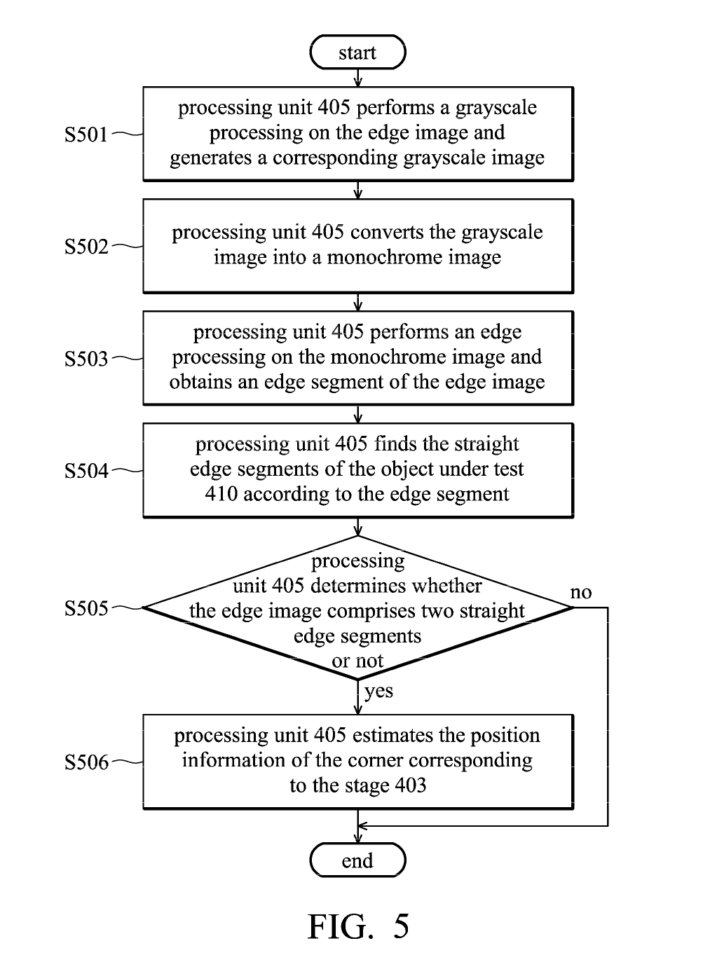

FIG. 5 is a flow diagram illustrating how the processing unit 405 analyzes the edge images to obtain the position (corner) information of the object under test 410. In step S501, the processing unit 405 performs a grayscale processing on the edge image and generates a corresponding grayscale image. In step S502, the processing unit 405 converts the grayscale image into a monochrome image. In step S503, the processing unit 405 performs an edge processing on the monochrome image and obtains an edge segment of the edge image.

In step S504, the processing unit 405 finds the straight edge segments of the object under test 410 according to the edge segment. In step S505, the processing unit 405 determines whether the edge image comprises two straight edge segments or not. Then the edge image is determined to be a corner image of the object under test 410, and the method proceeds to step S506 if the edge image comprises two straight edge segments. Otherwise the processing unit 405 finishes the analysis. In step S506, the processing unit 405 estimates the position of the corner corresponding to the stage 403.

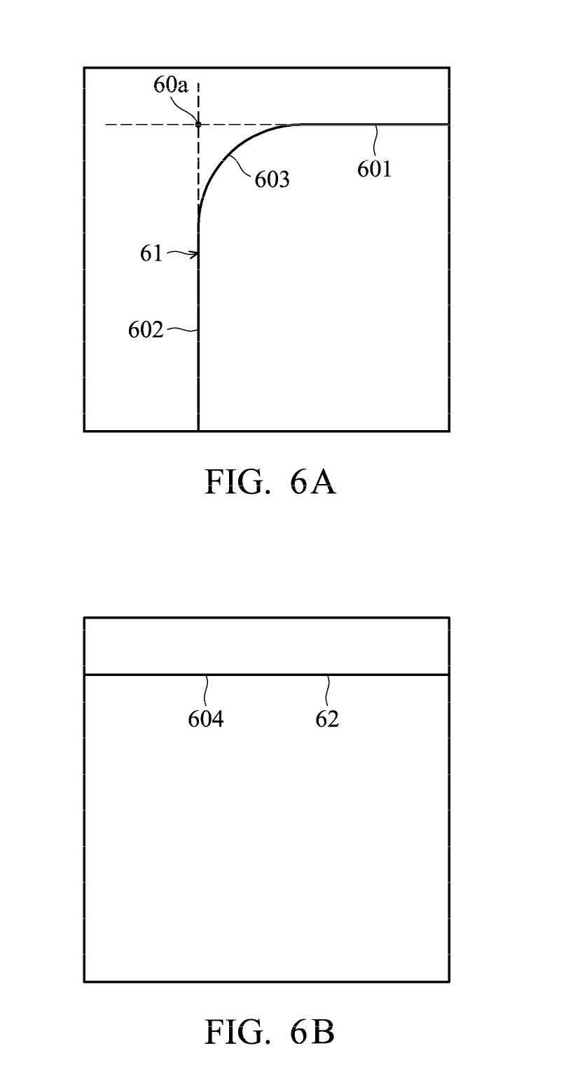

FIG. 6A shows the processing unit 405, through the above steps S501˜S503, analyzing the edge image 301 and obtaining an edge segment 61 of the edge image 301. As shown in FIG. 6A, the edge segment 61 is composed of an straight edge segment 601, an straight edge segment 602, and an edge corner segment 603. Then the processing unit 405 divides the edge segment 61 into N sample segments, wherein every sample segment has equal length and the straight edge segment 601, the straight edge segment 602 and the edge corner segment 603 comprise N₁, N₂ and N₃ sample segment, respectively, where N is equal to the sum of N₁, N₂ and N₃.

Since performing a Hough transformation on a straight line on the X-Y coordinate plane results in a coordinate point on the R-θ coordinate plane, the processing unit 405 performs the Hough transformation on the N₁ sample segments of the straight edge segment 601 on the X-Y coordinate plane and obtains N₁ equal coordinate points H₁ on the R-θ coordinate plane. Similarly, the processing unit 405 performs the Hough transformation on the N₂ sample segments of the straight edge segment 602 on the X-Y coordinate plane and obtains N₂ equal coordinate points H₂ on the R-θ coordinate plane. Additionally, the processing unit 405 performs the Hough transformation on the N₃ sample segments of the edge corner segment 603 with the X-Y coordinate plane and obtains at most N₃ different coordinate points H₃˜H_{(N3+2)} on the R-θ coordinate plane because the edge corner segment 603 is not a straight line.

Then the processing unit 405 finds out that the straight edge segment 601 is a straight line through N₁ equal coordinate points H₁ (step S504). The processing unit 405 finds out that the straight edge segment 602 is another straight line through N₂ equal coordinate points H₂ and H₂ is not equal to H₁ (step S504). The processing unit 405 also finds out that the edge corner segment 603 is not a straight line according to the at most N₃ different coordinate points H₃˜H_{(N3+2)} (step S504).

By using the above method, the processing unit 405 analyzes the edge segment 61 of the edge image 301 and determines the edge image 301 comprises two straight edge segments 601, 602 (step S505). Therefore the processing unit 405 find outs the edge image 301 is the corner image of the object under test 410 (step S505). The processing unit 405 estimates the position of the corner 60a of the object under test 410 according to the intersection of the extension line of two straight edge segments 601, 602 (step S506).

FIG. 6B shows the processing unit 405, through the above steps S501˜S503, analyzing the edge image 302 and obtaining an edge segment 62 of the edge image 302. First, the processing unit 405 divides the edge segment 62 into N sample segments, wherein every sample segment has equal length. The processing unit 405 performs the Hough transformation on the N sample segments of the edge segment 62 on the X-Y coordinate plane and obtains N equal coordinate points H₆₂ on the R-θ coordinate plane. Since the edge segment 62 is a straight line as shown in FIG. 6B, the processing unit 405 obtains N equal coordinate points H₆₂ on the R-θ coordinate plane.

The processing unit 405 finds out that the straight edge segment 604 of the edge image 302 according to the transformation result of the N equal coordinate points H62 (step S504). Then the processing unit 405 determines the edge image 302 only comprises one straight edge segment 604 and find outs the edge image 302 is not the corner image of the object under test 410 (step S505).

According to the embodiments described in FIG. 4, FIG. 5, FIG. 6A and FIG. 6B, the automatic alignment system 40 can obtain four position (corner) information of the object under test 410 from the edge images 301˜318. The processing unit 405 also records the moving distance of the movable platform 401 moving along the object under test 410 while controlling the driving device 404. Finally, the processing unit 405 can obtain the shape of the object under test 410 according to the moving distance and the position of the four corners of the object under test 410.

While the invention has been described by way of example and in terms of preferred embodiment, it is to be understood that the invention is not limited thereto. On the contrary, it is intended to cover various modifications and similar arrangements (as would be apparent to a person skilled in the art). Therefore, the scope of the appended claims should be accorded the broadest interpretation so as to encompass all such modifications and similar arrangements.

What is claimed is:

1. An automatic alignment system, comprising:
a stage, on which an object under test is placed;
a movable platform disposed above the stage;
an image recognition unit disposed on the movable platform, capturing a plurality of edge images of the object under test by way of the movable platform moving along the edge of the object under test; and
a processing unit coupled to the image recognition unit, receiving and analyzing each of the edge images from the image recognition unit, determining whether each of the edge images is a corner image of the object under test or not and estimating the position of the corner of the object under test corresponding to the stage when the edge image is determined to be the corner image.

2. The automatic alignment system of claim 1, wherein the processing unit analyzes each of the edge images, further comprising:
the processing unit performing a grayscale processing on the edge image and generating a corresponding grayscale image;
the processing unit converting the grayscale image into a monochrome image; and
the processing unit performing an edge processing on the monochrome image and obtaining one or more edge segments of the edge image.

3. The automatic alignment system of claim 2, wherein the processing unit finds at least an straight edge segment of the edge image according to the edge segment, and determines that the edge image is the corner image of the object under test when the edge image comprises two straight edge segments.

4. The automatic alignment system of claim 3, wherein the processing unit estimates the position of the corners of the object under test according to the intersection of the extension lines of the two straight edge segments.

5. The automatic alignment system of claim 4, further comprising a driving device coupled to the processing unit and the movable platform, wherein the processing unit controls the driving device to move the movable platform according to the straight edge segments and the position of each of the corners of the object under test.

6. The automatic alignment system of claim 5, wherein the processing unit controls the driving device to move the movable platform, obtaining the moving distance of the movable platform; the processing unit further obtaining the shape of the object under test according to the moving distance and the position of each of the corners of the object under test.

7. The automatic alignment system of claim 2, wherein the processing unit, through the Hough transformation, estimates the position of each of the corners of the object under test corresponding to the stage.

8. The automatic alignment system of claim 1, further comprising a storage unit to store the position of each of the corners corresponding to the stage.

9. An automatic alignment method, comprising:
placing an object under test on a stage;
disposing a movable platform above the stage;
disposing an image recognition unit on the movable platform;
capturing, by the image recognition unit, a plurality of edge images of the object under test by way of the movable platform moving along the edge of the object under test;
receiving and analyzing, by a processing unit, each of the edge images from the image recognition unit;
determining, by the processing unit, whether each of the edge images is a corner image of the object under test or not; and
estimating, by the processing unit, the position of the corner of the object under test corresponding to the stage when the edge image is determined to be the corner image.

10. The automatic alignment method of claim 9, wherein analyzing each of the edge images further comprises:
performing, by the processing unit, a grayscale processing on the edge image and generating a corresponding grayscale image;
converting, by the processing unit, the grayscale image into a monochrome image;
performing, by the processing unit, an edge processing on the monochrome image; and
obtaining, by the processing unit, one or more edge segments of the edge image.

11. The automatic alignment method of claim 10, further comprising:
finding, by the processing unit, at least an straight edge segment of the edge image according to the edge segment; and
determining, by the processing unit, the edge image is the corner image of the object under test when the edge image comprises two straight edge segments.

12. The automatic alignment method of claim 11, further comprising:
estimating, by the processing unit, the position of the corners of the object under test according to the intersection of the extension lines of the two straight edge segments.

13. The automatic alignment method of claim 11, further comprising:
estimating, by the processing unit, the position of each of the corner images of the object under test corresponding to the stage through the Hough transformation.
